(19) United States
(12) Patent Application Publication
(10) Pub. No.: US 2002/0064431 A1
(43) Pub. Date: May 30, 2002

(54) Pneumatic conveyor for containers

(76) Inventor: Keith A. Langenbeck, Dallas, TX (US)

Correspondence Address: CHRISTOPHER J. ROURK, AKIN, GUMP, STRAUSS, HAUER & FELD, L.L.P., P O BOX 688, DALLAS, TX, 75313-0688, US

(21) Appl. No.: 09/728,363

(22) Filed: Nov. 30, 2000

(51) Int. Cl. B65G 53/16

(52) U.S. Cl. 406/88

(57) ABSTRACT

A pneumatic conveyor for unfilled beverage and food containers includes an elongated generally rectangular cross section duct including a removable cover for providing access to the duct plenum chamber for cleaning purposes. The containers are supported by opposed adjustable rail members mounted on a bottom wall of the duct and including spaced apart low pressure air discharge nozzles oriented at an acute angle with respect to the longitudinal central axis of the conveyor to eject low pressure air on opposite sides of the containers to propel the containers linearly along the conveyor in a balanced manner. The nozzles cooperate with spaced apart openings formed in the bottom wall of the duct to receive low pressure air for ejection from the nozzles.

### FIELD OF THE INVENTION

The present invention pertains to a pneumatic conveyor system for traversing unfilled beverage containers, in particular, which containers are suspended on a guide track which includes pressure air nozzles in communication with a plenum of low pressure air and which nozzles are oriented to propel the unfilled containers along the conveyor.

### BACKGROUND

The beverage and other food processing industries are continuously in need of efficient container handling and transport equipment, such as conveyors for moving containers between processing steps associated with the production, filling and storage or transport of product filled containers. Container conveyors are necessary but unappreciated pieces of equipment within a beverage or food processing facility. The conveyors are desirably modular to permit easy reconfiguration as changes in processing steps are experienced. The cost of container conveyors should desirably be kept at a minimum. The conveyors must be capable of easy cleaning, periodically, to comply with cleanliness requirements and procedures within the container handling or filling facility. Still further, it is desirable to maximize the efficiency of pneumatic containers to save energy costs.

All of the above desired features in pneumatic conveyors for beverage containers and the like are difficult to satisfy with a conveyor design which is inexpensive to manufacture and reliable in operation. However, it is to these ends that the present invention has been developed.

### SUMMARY OF THE INVENTION

The present invention provides an improved pneumatic conveyor for containers, particularly unfilled containers used in the beverage and other food processing industries.

In accordance with one aspect of the present invention, an improved pneumatic conveyor is provided which is mechanically uncomplicated and is characterized by an elongated duct structure which may be support at spaced apart points by upstanding support legs and is preferably fabricated in predetermined lengths for modular installation and changes in installation configurations. The duct structure includes a removable top cover to provide access to a pneumatic plenum chamber formed by the duct structure.

In accordance with another aspect of the invention, a pneumatic conveyor is provided which includes a configuration of a container support track formed by opposed elongated rail-like members which are laterally adjustable and are configured to support a variety of containers, primarily by a flanged neck portion of the container. The opposed elongated rail members include depending flanges for deflecting and redirecting airflow impinging on the containers to improve propulsion efficiency. The rail members are laterally adjustable to provide for optimizing the clearance space between the rail members while providing suitable support for the containers as they traverse the container system.

In accordance with another aspect of the invention, the above-mentioned conveyor track rail members are provided with spaced apart low pressure air ejection nozzles which are of an improved design and are easily fabricated along with the rail member itself.

In accordance with still a further aspect of the present invention, an improved pneumatic conveyor for food and beverage containers is provided which is mechanically uncomplicated, easy to fabricate, reliable in operation, easy to clean, when required, and generally improves the efficiency of and reduces the cost of transporting food and beverage containers.

Those skilled in the art will further appreciate the above-mentioned advantages and superior features of the invention upon reading the detailed description which follows in conjunction with the drawings.

### BRIEF DESCRIPTION OF THE DRAWINGS

FIG. 1 is a side elevation of a pneumatic conveyor in accordance with the present invention;

FIG. 2 is an end view of the conveyor shown in FIG. 1;

FIG. 3 a section view taken generally from the line 3-3 of FIG. 1;

FIG. 4 is a view of the duct structure for the conveyor of the present invention taken generally from the line 4-4 of FIG. 4 with the duct cover removed and the container support rail members disassembled from the duct; and

FIG. 5 is a detail section view taken from the line 5-5 in FIG. 4.

### DETAILED DESCRIPTION OF A PREFERRED EMBODIMENT

In the description which follows, like parts are marked throughout the specification and drawing with the same reference numerals, respectively. The drawing figures are not necessarily to scale and certain features may be shown in somewhat generalized or schematic form in the interest of clarity and conciseness.

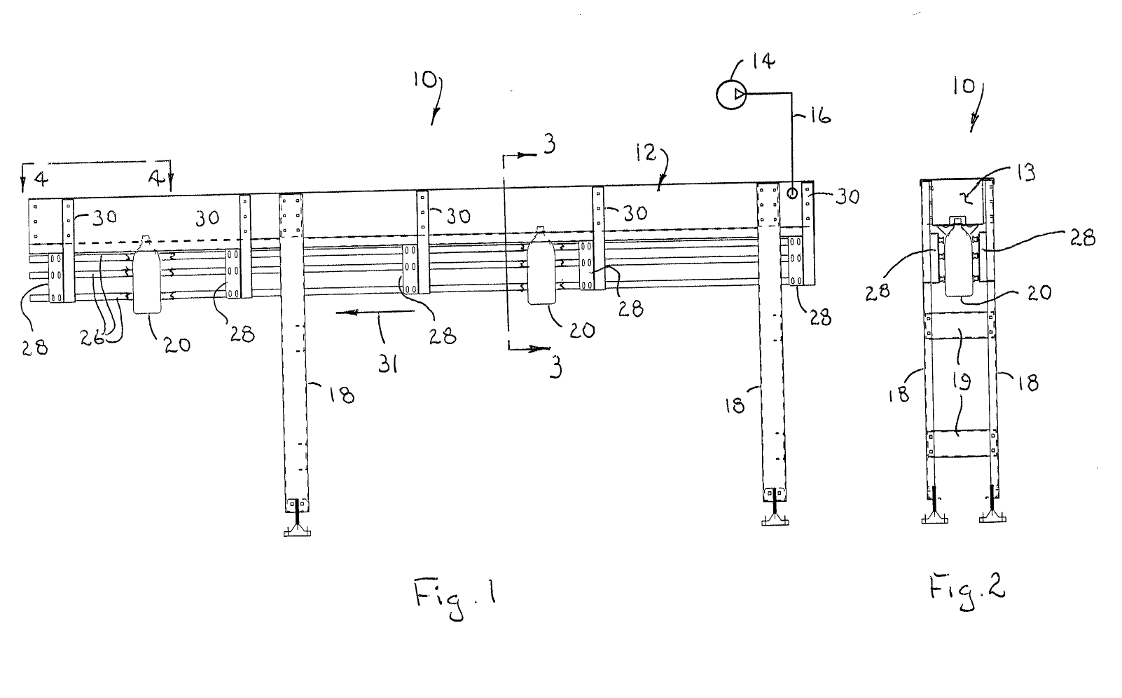

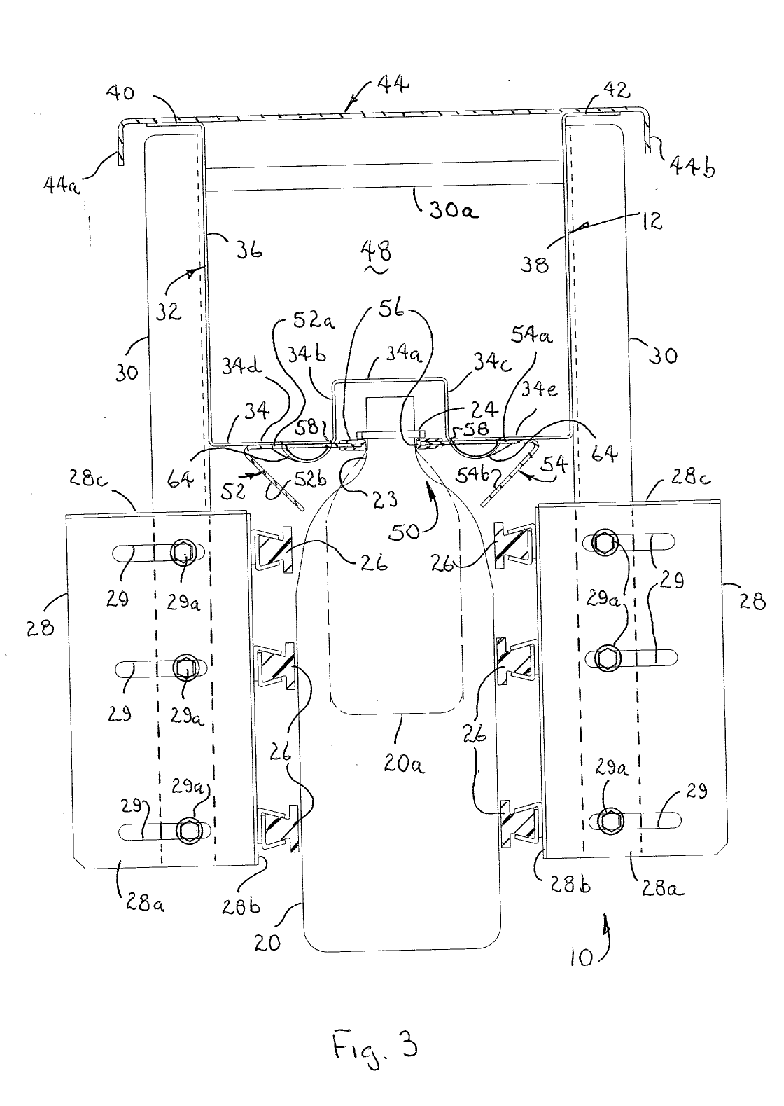

Referring to FIGS. 1 and 2, there is illustrated a section of a pneumatic conveyor in accordance with the invention and generally designated by the numeral 10. The conveyor 10 may be made up of multiple sections in accordance with the section shown in FIGS. 1 and 2. The conveyor includes an elongated generally rectangular cross section closed duct 12 which is in communication with a source, such as a blower 14, of high volume, lower pressure air, normally at a gauge pressure of about four to six inches water. Pressure air is conducted from blower 14 to duct 12 by way of a suitable conduit 16. The duct 12 is supported on spaced apart pairs of adjustable channel shaped support legs 18, as shown in FIGS. 1 and 2. Multiple sections of the conveyor 10 may be supported end to end for pneumatic conveyance of various sizes of unfilled generally cylindrical beverage or food containers 20, as shown. The legs 18 are suitably interconnected by cross braces 19. The legs 18 are also suitably connected to the duct 12 by conventional mechanical fasteners, not shown in FIGS. 1 and 2.

For sake of discussion herein and as shown in FIGS. 1, 2 and 3, the conveyor 10 is advantageously adapted to convey the containers 20 which are configured as plastic beverage containers which may be of various sizes. As shown in FIG. 3, a larger size container 20 is illustrated by solid lines and a significantly smaller container 20a is indicated by dashed lines. Several intermediate sizes of containers, not shown, may also be conveyed by the conveyor 10. Container 20 includes a reduced diameter cylindrical neck 23 having a circumferential flange 24 formed thereon.

The containers 20 or 20a, or any intermediate container sized therebetween, are operable to be guided along the conveyor 10 by opposed sets of elongated guide members 26 which are spaced apart, as shown in FIGS. 1 and 3 and are suitably mounted on spaced apart adjustable support brackets 28. Support brackets 28 are each mounted on opposed depending channel shaped support columns 30 which are suitably secured to the duct 12 by conventional mechanical fasteners, not shown. Columns 30 and duct 12 are reinforced by cylindrical rod cross brace members 30a, one shown in FIG. 3, and which extend between respective pairs of columns 30 for the conveyor 10. The section of the conveyor 10 illustrated in FIGS. 1 and 2 is preferably fabricated in 10-foot lengths. An end section will have a closure over one end of the duct 12 to contain low pressure air therewithin, which closure is indicated by the numeral 13 in FIG. 2. However, intermediate sections of conveyor 10 will be open at opposite ends and suitably joined to the section shown in FIGS. 1 and 2 by conventional mechanical fasteners. The direction of conveyance of the containers 20 is in accordance with the arrow 31 in FIG. 1.

Referring now primarily to FIG. 3, the duct 12 comprises an elongated somewhat rectangular cross section-shaped duct member 32 having a bottom wall 34 and upstanding spaced apart parallel sidewalls 36 and 38. Sidewalls 36 and 38 terminate in opposed coplanar flanges 40 and 42. Bottom wall 34 is interrupted by a generally rectangular cross section inverted channel or recessed portion formed by a horizontal web 34a and opposed vertical sidewalls 34b and 34c, leaving opposed horizontal coplanar wall portions 34d and 34e formed between the recessed portion and the upstanding sidewalls 36 and 38, as shown. The duct member 32 is preferably of rolled or extruded metal or plastic construction. The duct 12 is closed by a cover member 44 removably supported on the flanges 40 and 42 by conventional mechanical fasteners, not shown in FIG. 3. The cover member 44 is preferably a relatively thin metal plate having a shallow channel-shaped cross section with opposed depending flanges 44a and 44b to increase the rigidity of the cover. Accordingly, a closable plenum chamber 48 is formed within the duct 12 and is operable to be charged with low pressure air from the source 14 by way of conduit 16.

Referring further to FIG. 3, the guide member support brackets 28 are indicated to be angle-shaped members having opposed flanges 28a and 28b which extend normal to each other. A reinforcing gusset 28c may be provided on the brackets 28. Spaced apart elongated slots 29 are formed in the flanges 28a for supporting the brackets 28 on the column members 30 by suitable mechanical fasteners 29a, as shown. Accordingly, the spacing between the guide members 26 may be suitably adjusted by positioning the brackets 28 with respect to the column members 30 in a manner believed to be understandable to those of skill in the art.

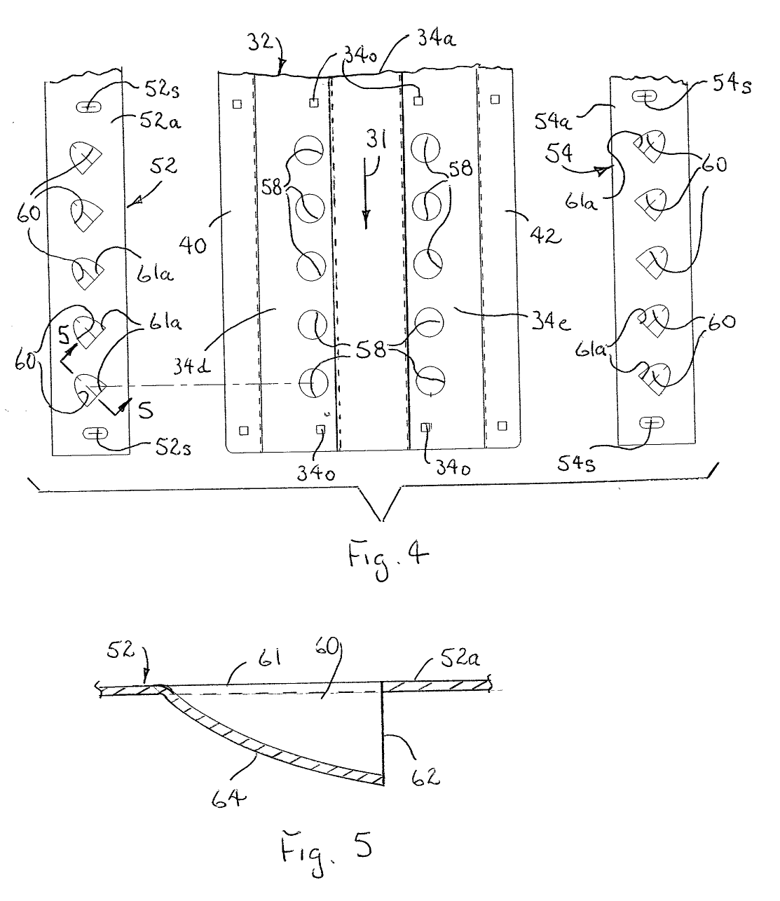

Referring still further to FIG. 3, and also FIG. 4, the containers 20 are supported for linear traversal along the conveyor 10 by a track 50 comprising opposed elongated rail members 52 and 54, each having a first generally planar flange 52a and 54a and a second generally planar flange 52b and 54b, respectively. The flanges 52b and 54b are each disposed at an acute angle with respect to the flanges 52a and 54a and project toward the container 20 when the guide rails 52 and 54 are supported on the duct member 32. Elongated somewhat U-shaped or channel-shaped elastomer cap members 56 are sleeved over the distal ends of the flanges 52a and 54a to form low friction support surfaces for the container flange 24, as shown in FIG. 3. The container support rails 52 and 54 are supported on the duct bottom wall parts 34d and 34e by mechanical fasteners, not shown in FIGS. 3 or 4, and are substantially coextensive with such wall parts. However, the flanges 52a and 54a are provided with elongated transverse slots 52s and 54s, FIG. 4, which are cooperable with openings 34o formed in the opposed bottom wall portions 34d and 34e of the duct member 32 whereby the lateral positions of the rail members 52 and 54 may be adjusted to change the spacing between the rail members to accommodate containers having different neck diameters.

An important aspect of the invention is provided by the duct member 32 and the rail members 52 and 54. As shown in FIG. 4, the bottom wall portions 34d and 34e are provided with parallel sets of spaced apart generally cylindrical openings 58 formed therein, respectively. The openings or ports 58 cooperate with nozzles 60 formed in the respective rail members 52 and 54 to provide for ejecting low pressure air into the space between the flanges 52b and 54b, FIG. 3, of the rail members to propel containers 20 efficiently along the conveyor 10 in the direction of arrow 31 in FIGS. 1 and 4. When the rail members 52 and 54 are assembled to the duct member 32, as shown in FIG. 3, the nozzles 60 register with the openings 58 to provide for communication of low pressure air from the plenum chamber 48 through and out of the nozzles and into the space between the rail flanges 52b and 54b. As shown by way of example in FIGS. 4 and 5, each of the nozzles 60 includes an inlet opening 61 and a discharge opening 62, FIG. 5, delimited by a somewhat ellipsoid-shaped nozzle wall 64. The longitudinal axis of each nozzle 60 as defined by the line designating the plane of FIG. 5 is directed at an angle to the longitudinal axis of the duct member 32, as defined by the arrow 31, at an angle of about 45°. Accordingly, an axial component of the velocity of low pressure air emanating from the nozzle openings 62 acts with substantially equal forces on both sides of a container 20 to propel the container along the track 50 in an efficient manner. The openings 58 and the nozzles 60 are of sufficient cross sectional area and positioned relative to each other such that the rail members 52 and 54 may be adjusted laterally with respect to each other while providing adequate cross sectional flow area of the cooperable openings 58 and 61 to allow the flow of low pressure air sufficiently into the space between the rail flanges 52b and 54b to effectively propel the containers 20 along the conveyor 10.

Those skilled in the art will appreciate the advantageous configuration of the track 50 including the rail members 52 and 54 and the arrangement of propulsion air nozzles 60 which cooperate with the openings 58 in the duct member 32. The duct member 32 and the rail members 52 and 54 may be easily fabricated from folded sheet metal, for example, which is operable to undergo a suitable punch or coining operation to provide the openings 58 and 34o in the duct member 32 and the nozzles 60 and the slots 52s and 54s in the rail members 52 and 54. The nozzles 60 are formed by cutting through the flanges 52a and 54a along the lines 61a, FIG. 4, and displacing the material of the flanges 52a and 54a to form the nozzle walls 64 and nozzle discharge openings 62.

Those skilled in the art will also appreciate that the conveyor 10 may be easily cleaned, if necessary, by removing the cover member 44 so that the interior of the duct member 32 may be easily cleaned by a high pressure water jet or the like, for example. Accordingly, the collection of any type of debris within the duct member 32 or at the openings 58 or in or on the nozzles 60 and on the members 52 and 54 may be easily removed using conventional cleaning procedures practiced at food processing facilities.

Those skilled in the art will further appreciate that the track 50 may be easily adjusted, as needed, for different container sizes and the rail members 52 and 54 may be easily replaced, if necessary.

The construction and operation of the conveyor 10 is believed to be understandable to those of ordinary skill in the art based on the foregoing description. Conventional engineering materials and manufacturing practices may be carried out in fabricating the conveyor 10 and its component parts.

Although a preferred embodiment of the invention has been described in detail herein, those skilled in the art will also recognize that various substitutions and modifications may be made without departing from the scope and spirit of the appended claims.

What is claimed is:

1. A pneumatic conveyor for containers, said containers each having a part thereon adapted for supporting said container and providing for propulsion of said container along said conveyor by pressure air impinging thereon, said conveyor comprising:
an elongated duct member, said duct member including opposed sidewalls and a bottom wall;
an elongated track for supporting said containers for linear traversal along said conveyor, said track including opposed rail members supported adjacent said bottom wall of said duct member and defining spaced apart flanges engageable with said containers; and
said rail members and said duct member include cooperating nozzles on said rail members and openings in said duct member for conducting pressure air to impinge on containers supported by said rail members for propelling said containers along said conveyor.

2. The conveyor set forth in claim 1 including:
a cover on said duct member and closing a plenum chamber in said duct member, said cover being removable from said duct member to provide access to the interior of said duct member for cleaning said interior of said duct member and said openings in said bottom wall.

3. The conveyor set forth in claim 1 wherein:
said rail members are laterally adjustable on said duct member to support different sizes of said containers.

4. The conveyor set forth in claim 1 wherein:
said rail members include opposed first flanges spaced apart sufficient to support said containers and said rail members each include a second flange forming an acute angle with said first flange, respectively, to channel pressure air toward said container to propel said container along said conveyor.

5. The conveyor set forth in claim 4 wherein:
said nozzles open toward a central axis of said conveyor at an acute angle to provide an axial velocity component of pressure air acting on said containers.

6. The conveyor set forth in claim 5 wherein:
said nozzles are formed by displacing portions of first flanges of said rail members, respectively, to form nozzle wall parts and nozzle discharge openings, respectively.

7. The conveyor set forth in claim 6 wherein:
said nozzles include inlet openings formed in said first flanges and said wall parts are displaced from the plane of said first flanges, respectively, to form said discharge opening for each of said nozzles.

8. The conveyor set forth in claim 7 wherein:
said wall part of said nozzle forms a partial ellipsoid shape.

9. The conveyor set forth in claim 1 including:
elongated spaced apart linear guide members for said containers, said guide members being supported by opposed support members of said conveyor and laterally adjustable for guiding different sizes of containers along said conveyor, respectively.

10. A pneumatic conveyor for containers, said containers each having a part thereon adapted for supporting said container and providing for propulsion of said container along said conveyor by pressure air impinging thereon, said conveyor comprising:
an elongated duct member, said duct member including opposed sidewalls and a bottom wall;
a removable cover connected to said duct member and closing a plenum chamber in said duct member;
an elongated track for supporting said containers for linear traversal along said conveyor, said track including opposed rail members connected to said bottom wall of said duct member and engageable with said containers; and
longitudinally spaced nozzles on said rail members, respectively, in communication with said plenum chamber for conducting pressure air from said plenum chamber to impinge on containers supported by said rail members for propelling said containers along said conveyor.

11. The conveyor set forth in claim 10 wherein:
said rail members are laterally adjustable on said duct member to support different sizes of said containers.

12. The conveyor set forth in claim 10 wherein:
said rail members include opposed first flanges spaced apart sufficient to support said containers and said rail members each include a depending second flange operable to deflect the flow of pressure air from said nozzles to assist in propelling said containers along said conveyor.

13. The conveyor set forth in claim 10 wherein:
said nozzles open toward a central axis of said conveyor at an acute angle to provide an axial velocity component of pressure air acting on said containers.

14. The conveyor set forth in claim 13 wherein:
said nozzles are formed by displacing portions of said rail members, respectively, to form nozzle wall parts and nozzle discharge openings, respectively.

15. The conveyor set forth in claim 14 wherein:
said nozzles include inlet openings formed in said rail members and said wall parts are displaced, respectively, to form discharge openings for each of said nozzles.

16. A pneumatic conveyor for containers, said containers each having a part thereon adapted for supporting said container and providing for propulsion of said container along said conveyor by pressure air impinging thereon, said conveyor comprising:
an elongated duct member, said duct member including opposed sidewalls and a bottom wall, said bottom wall including a part forming a clearance channel for said containers and opposed bottom wall portions adjacent said clearance channel, respectively;
plural longitudinally spaced apart openings in said opposed bottom wall portions;
a cover connected to said duct member and closing a plenum chamber in said duct member, said cover being removable from said duct member to provide access to the interior of said duct member for cleaning said interior of said duct member and said openings in said opposed bottom wall portions;
an elongated track for supporting said containers for linear traversal along said conveyor, said track including opposed rail members supported adjacent said opposed bottom wall portions and defining spaced apart flanges engageable with said containers; and
plural longitudinally spaced apart nozzles on said rail members and cooperating with said openings in said bottom wall portions, respectively, for conducting pressure air from said plenum chamber to impinge on containers supported by said rail members for propelling said containers along said conveyor.

17. The conveyor set forth in claim 16 wherein:
said nozzles open toward a central axis of said conveyor at an acute angle to provide an axial velocity component of pressure air acting on said containers.

18. The conveyor set forth in claim 17 wherein:
said nozzles are formed by displacing portions of said rail members, respectively, to form nozzle wall parts and nozzle discharge openings, respectively.
